(19) United States
(12) Patent Application Publication
(10) Pub. No.: US 2015/0304963 A1
(43) Pub. Date: Oct. 22, 2015

(54) Method To Improve Throughput in Multi-SIM-Multi-Active Scenario Using Adaptive Transmit Blanking of Data and Control Channels

(71) Applicant: QUALCOMM Incorporated, San Diego, CA (US)

(72) Inventors: Soumen Mitra, Hyderabad (IN); Anand Rajurkar, Hyderabad (IN); Aritra Ukil, Hyderabad (IN)

(73) Assignee: QUALCOMM Incorporated, San Diego, CA (US)

(21) Appl. No.: 14/255,138

(22) Filed: Apr. 17, 2014

(51) Int. Cl. H04W 52/34; H04B 1/12

(52) U.S. Cl. CPC H04W 52/346; H04B 1/123

(57) ABSTRACT

Various embodiments provide methods implemented on a multi-SIM-multi-active (MSMA) communication device for managing a victim subscription's de-sense by reducing transmit power of an aggressor subscription's data channel(s) before reducing transmit power of the control channel. When the victim is being/will be de-sensed, a processor of the MSMA communication device may determine a de-sense power threshold at which an aggressor subscription may transmit without de-sensing one or more victim subscriptions. The processor may reduce the transmit power of the aggressor subscription's data channel(s) to within the de-sense power threshold. If zeroing the aggressor subscription's data channel(s) transmit power is insufficient to avoid de-sense of the victim, the transmit power of the aggressor subscription's control channel may be reduced until the total transmit power of the aggressor subscription equals or is less than the de-sense power threshold. This reduces de-sense to the victim subscription with minimum impairment to the aggressor subscription's throughput.

### BACKGROUND

Some new designs of mobile communication devices—such as smart phones, tablet computers, and laptop computers—contain two or more Subscriber Identity Module (“SIM”) cards that provide users with access to multiple separate mobile telephony networks. Examples of mobile telephony networks include GSM, TD-SCDMA, CDMA2000, and WCDMA. Example multi-SIM mobile communication devices include mobile phones, laptop computers, smart phones, and other mobile communication devices that are configured to connect to multiple mobile telephony networks. A mobile communication device that includes a plurality of SIMs and connects to two or more separate mobile telephony networks using two or more separate radio-frequency (“RF”) transceivers is termed a “multi-SIM-multi-active” or “MSMA” communication device. An example MSMA communication device is a “dual-SIM-dual-active” or “DSDA” communication device, which includes two SIM cards/subscriptions associated with two mobile telephony networks.

Because a multi-SIM-multi-active communication device has a plurality of separate RF communication circuits or “RF chains,” each subscription on the MSMA communication device may use its associated RF chain to communicate with its mobile network at any time. However, in certain band-channel combinations of operation, the simultaneous use of the RF chains may cause one or more RF chains to desensitize or interfere with the ability of the other RF chains to operate normally because of the proximity of the antennas of the RF chains included in the MSMA communication device.

Generally, receiver desensitization (referred to as “de-sense”), or degradation of receiver sensitivity, may result from noise interference of a nearby transmitter. For example, when two radios are close together with one transmitting on the uplink—referred to as the aggressor communication activity (“aggressor”)—and the other receiving on the downlink—referred to as the victim communication activity (“victim”)—signals from the aggressor's transmitter may be picked up by the victim's receiver or otherwise interfere with reception of a weaker signal (e.g., from a distant base station). As a result, the received signals may become corrupted and difficult or impossible for the victim to decode. Receiver de-sense presents a design and operational challenge for multi-radio devices, such as MSMA communication devices, due to the necessary proximity of transmitter and receiver.

### SUMMARY

Various embodiments provide methods, devices, and non-transitory processor-readable storage media for mitigating de-sense on a second communication activity caused by a first communication activity in a multi-Subscriber-Identity-Module, multi-active communication device.

Some embodiment methods may include calculating, within the multi-SIM-multi-active communication device, a de-sense power threshold for the first communication activity as a maximum transmit power of the first communication activity that does not de-sense the second communication activity, in response to detecting a coexistence event between the first communication activity and the second communication activity and reducing at least one of a data channel power and a control channel power of the first communication activity within the multi-SIM-multi-active communication device such that a total transmit power associated with the first communication activity equal to a sum of the data channel power and the control channel power does not exceed the de-sense power threshold, wherein the data channel power is reduced to zero before the control channel power is reduced.

In some embodiments, detecting a coexistence event between the first communication activity and the second communication activity may include one of determining that a coexistence event is about to occur between the first communication activity and the second communication activity and determining that a coexistence event is occurring between the first communication activity and the second communication activity.

In some embodiments, reducing at least one of a data channel power and a control channel power of the first communication activity may include determining whether the de-sense power threshold is less than the total transmit power, determining whether the control channel power exceeds the de-sense power threshold, in response to determining that the de-sense power threshold is less than the total transmit power, and reducing only the data channel power so that the total transmit power does not exceed the de-sense power threshold, in response to determining that the control channel power does not exceed the de-sense power threshold. Some embodiment methods may further include zeroing the data channel power before reducing the control channel power to equal the de-sense power threshold, in response to determining that the control channel power exceeds the de-sense power threshold.

In some embodiments, the first communication activity may be associated with a plurality of data channels, and reducing at least one of a data channel power, and a control channel power of the first communication activity may include selecting a data channel in the plurality of data channels, determining whether a difference between the total transmit power and a channel power of the selected data channel exceeds the de-sense power threshold, and reducing the channel power of the selected data channel so that the total transmit power equals the de-sense power threshold, in response to determining that the difference does not exceed the de-sense power threshold. Some embodiment methods may further include zeroing the channel power of the selected data channel in response to determining that the difference exceeds the de-sense power threshold.

In some embodiments, each of calculating a de-sense power threshold and reducing at least one of a data channel power and a control channel power of the first communication activity such that a total transmit power associated with the first communication activity does not exceed the de-sense power threshold may occur during each uplink transmit cycle of the first communication activity.

In some embodiments, calculating a de-sense power threshold for the first communication activity may include calculating the de-sense power threshold for the first communication activity as a maximum transmit power of the first communication activity that does not de-sense a plurality of other communication activities.

Various embodiments may include a multi-SIM-multi-active communication device configured with processor-executable instructions to perform operations of the methods described above.

Various embodiments may include a multi-SIM-multi-active communication device having means for performing functions of the operations of the methods described above.

Various embodiments may include non-transitory processor-readable media on which are stored processor-executable instructions configured to cause a processor of a multi-SIM-multi-active communication device to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of mobile telephony networks suitable for use with various embodiments.

FIG. 2 is a component block diagram of a multi-SIM-multi-active communications device according to various embodiments.

FIG. 3 is a component block diagram illustrating the interaction between components of different transmit/receive chains in a multi-SIM-multi-active communications device according to various embodiments.

FIGS. 4A-4C are transmit power graphs illustrating examples of reducing a data channel transmit power or a data channel transmit power and a control channel transmit power based on de-sense power threshold values according to various embodiments.

FIG. 5 is a signal diagram illustrating applying transmit power gains to a data channel and a control channel to affect the channels' transmit powers according to various embodiments.

FIG. 6 is a process flow diagram illustrating a method for reducing at least one of a transmit power of a data channel and a transmit power of a control channel in response to determining that an aggressor subscription's total transmit power exceeds a de-sense power threshold according to various embodiments.

FIG. 7 is a process flow diagram illustrating a method for selectively reducing the transmit powers of one or more data channels in a plurality of data channels to ensure that a total transmit power does not exceed a de-sense power threshold according to various embodiments.

FIG. 8 is a component block diagram of a multi-SIM-multi-active communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term “MSMA communication device” refers to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices that include multiple SIMs, a programmable processor, memory, and circuitry for connecting to at least two mobile communication networks simultaneously. Various embodiments may be useful in mobile communication devices, such as smart phones, and so such devices are referred to in the descriptions of various embodiments. However, the embodiments may be useful in any electronic devices, such as a DSDA communication device, that may individually maintain a plurality of subscriptions that utilize a plurality of separate RF resources.

As used herein, the terms “SIM”, “SIM card” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “SIM” is also be used herein as a shorthand reference to the communication service associated with and enabled by the information stored in a particular SIM as the SIM and the communication network, as well as the services and subscriptions supported by that network, correlate to one another.

As described above, one or more subscriptions on a MSMA communication device may negatively affect the performance of other subscriptions operating on the MSMA communication device. For example, a DSDA communication device may suffer from intra-device interference when an aggressor subscription is attempting to transmit while a victim subscription in the DSDA communication device is simultaneously attempting to receive transmissions. During such a “coexistence event,” the aggressor subscription's transmissions may cause severe impairment to the victim's ability to receive transmissions. This interference may be in the form of blocking interference, harmonics, intermodulation, and other noises and distortion received by the victim. Such interference may significantly degrade the victim's receiver sensitivity, voice call quality and data throughput. These effects may also result in a reduced network capacity of the MSMA communication device.

Further, subscriptions' activities may change during the ordinary course of operating on a MSMA communication device, such as when a subscription ceases a transmission cycle and begins a reception cycle or when the band-channel combination of the victim subscription and the aggressor subscription changes, causing the aggressor subscription to de-sense the victim subscription. In such instances, an aggressor subscription at a first time may become a victim subscription at a second time, and the victim subscription at the first time may similarly become an aggressor subscription at a second or third time. Thus, while various embodiments are primarily described with reference to an aggressor subscription and a victim subscription, the subscriptions are referred to generally as a first communication activity and a second communication activity to reflect that the subscriptions' roles as an aggressor or a victim may change.

In many conventional solutions implemented on a MSMA communication device for mitigating victim subscription de-sense, the MSMA communication device configures the aggressor subscription to reduce its transmit power or stop transmitting (i.e., the device configures the victim subscription to perform transmit (“Tx”) blanking) while the victim subscription is receiving transmissions. In current implementations of these solutions, the aggressor subscription's data and control channels are both reduced partially or entirely without distinction.

The control channel is used to communicate information that is critical for maintaining a satisfactory connection with a mobile network. For example, the control channel includes pilot information, the Transport Format Combination Indicator (“TFCI”) information for decoding symbols received from the network, a feedback indicator (“FBI”), and power control information (e.g., traffic power control (“TPC”) data). When the transmit power of the aggressor's control channel is reduced, the mobile network associated with the aggressor subscription may experience misalignment of fingers in a rake receiver because of a loss of pilot information, erroneous decoding of consecutive frames because of the loss of the TFCI information, loss of power control on subsequent frames as a result of loss of the TPC, etc. Each of these effects may increase the error probability of subsequent received information from the network and may decrease the aggressor subscription's overall throughput. Thus, while current solutions for utilizing Tx blanking are effective at reducing the victim subscription's de-sense, the improvement to the victim's reception performance is often at the expense of the aggressor subscription's performance because the aggressor subscription's control channel is blanked/reduced in addition to data channels.

Further, some conventional implementations on a mobile communication device involve applying a scaling procedure on the device to reduce the power of the device's data channels and control channels when a mobile computing device has reached a maximum transmission power (sometime referred to as a “maximum power problem”). However, current solutions to maximum power problems are not relevant to mitigating a victim subscription's de-sense during a coexistence event occurring on a MSMA communication device that includes multiple RF resources as described below in various embodiments because an aggressor subscription may de-sensing a victim subscription without transmitting at a maximum power.

Other convention implementations on mobile communications device involve reducing channel power of a mobile communication device to resolve a maximum power problem by applying different scaling factors for data channels and control channels. However, these solutions disclose that the scaling factors are generated by a network device (e.g., a base station or network device) for use on a mobile computing device. Specifically, these solutions require a network device to analyze power information received from a mobile communication device about the device's data and control channels and to compute appropriate scaling factors for the channels based on this analysis. In contrast, various embodiments described in the disclosure may adjust/reduce the transmit powers of data channels and control channels locally on the MSMA communication device (i.e., without any interaction with an external source, such as a network device or base station).

Thus, in overview, various embodiments provide methods implemented on a MSMA communication device (e.g., a DSDA communication device) for managing a victim subscription's de-sense by implementing an adaptive and progressive Tx blanking mechanism in which the transmit power of an aggressor subscription's data channel(s) is/are reduced before the aggressor subscription's control channel's transmit power is reduced. In various embodiments, in response to detecting that the victim is being de-sensed (i.e., in response to detecting a coexistence event), a processor operating on the MSMA communication device may determine a de-sense power threshold that indicates the maximum power at which an aggressor may transmit without de-sensing one or more victim subscriptions. The processor may also reduce the transmit power of the aggressor subscription's data channel(s) and, if necessary, the transmit power of the aggressor subscription's control channel until the total transmit power of the aggressor subscription does not exceed the de-sense power threshold. Thus, various embodiments may maintain the victim subscription's overall reception performance without significantly impairing the aggressor subscription's throughput by prioritizing the aggressor's control channel transmit power over the aggressor's data channel(s) transmit power.

In further embodiments, the aggressor subscription may be associated with a plurality of data channels, and the processor executing on the MSMA communication device may selectively reduce/zero one or more of the plurality of data channels to reduce the aggressor's total transmit power to equal the de-sense power threshold. For example, the processor may zero two of six data channels and may not reduce the transmit power of the remaining four data channels. Thus, rather than negatively impacting the performance of all data channels equally, the device processor may sacrifice the performance of some data channels for the benefit of others.

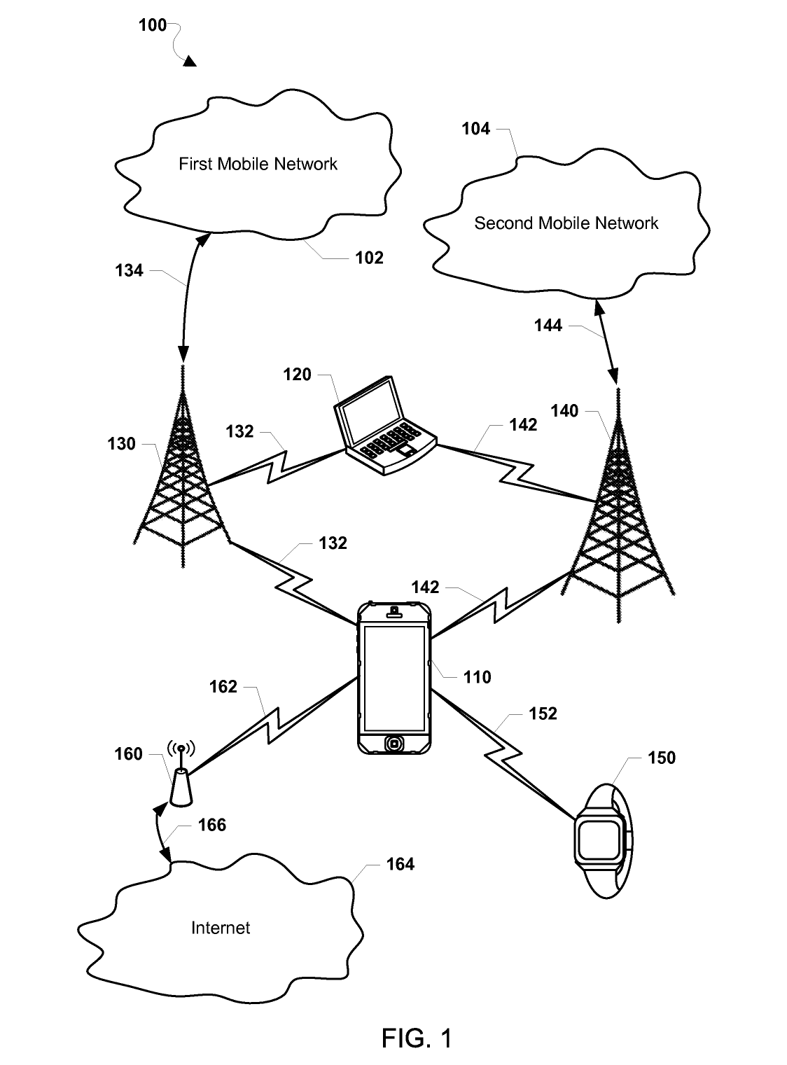

Various embodiments may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first MSMA communication device 110 may be in communication with the first mobile network 102 through a cellular connection 132 to the first base station 130. The first MSMA communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second MSMA communication device 120 may similarly communicate with the first mobile network 102 through the cellular connection 132 to the first base station 130. The second MSMA communication device 120 may communicate with the second mobile network 104 through the cellular connection 142 to the second base station 140. The cellular connections 132 and 142 may be made through two-way wireless communication links, such as 4G, 3G, CDMA, TDMA, WCDMA, GSM, and other mobile telephony communication technologies.

While the MSMA communication devices 110, 120 are shown connected to the mobile networks 102, 104, in some embodiments (not shown), the MSMA communication devices 110, 120 may include two or more subscriptions to two or more mobile networks and may connect to those subscriptions in a manner similar to those described above.

In some embodiments, the first MSMA communication device 110 may establish a wireless connection 152 with a peripheral device 150 used in connection with the first MSMA communication device 110. For example, the first MSMA communication device 110 may communicate over a Bluetooth® link with a Bluetooth-enabled personal computing device (e.g., a “smart watch”). In some embodiments, the first MSMA communication device 110 may establish a wireless connection 162 with a wireless access point 160, such as over a Wi-Fi connection. The wireless access point 160 may be configured to connect to the Internet 164 or another network over a wired connection 166.

While not illustrated, the second MSMA communication device 120 may similarly be configured to connect with the peripheral device 150 and/or the wireless access point 160 over wireless links.

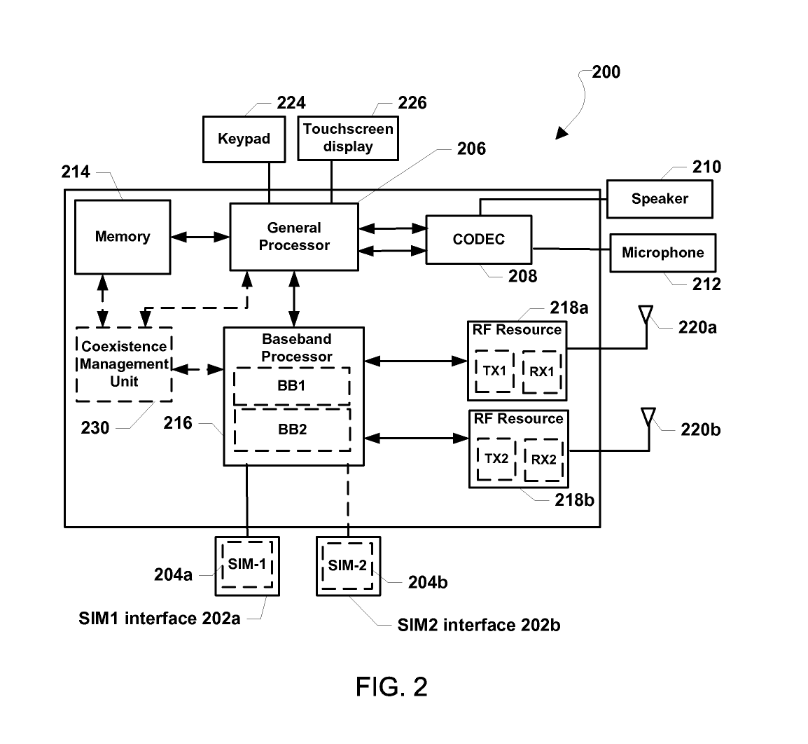

FIG. 2 is a functional block diagram of an MSMA communication device 200 suitable for implementing various embodiments. According to various embodiments, the MSMA communication device 200 may be similar to one or more of the MSMA communication devices 110, 120 as described with reference to FIG. 1. The MSMA communication device 200 may include a first SIM interface 202a, which may receive a first identity module SIM-1 204a that is associated with a first subscription. The MSMA communication device 200 may also include a second SIM interface 202b, which may receive a second identity module SIM-2 204b that is associated with a second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the MSMA communication device 200, and thus need not be a separate or removable circuit, chip or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The MSMA communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory processor-readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure.

The general purpose processor 206 and the memory 214 may each be coupled to at least one baseband modem processor 216. Each SIM in the MSMA communication device 200 (e.g., the SIM-1 202a and the SIM-2 202b) may be associated with a baseband-RF resource chain. A baseband-RF resource chain may include the baseband modem processor 216, which may perform baseband/modem functions for communications on at least one SIM, and may include one or more amplifiers and radios, referred to generally herein as RF resources 218a, 218b. In some embodiments, baseband-RF resource chains may share the baseband modem processor 216 (i.e., a single device that performs baseband/modem functions for all SIMs on the MSMA communication device 200). In other embodiments, each baseband-RF resource chain may include physically or logically separate baseband processors (e.g., BB1, BB2).

The RF resources 218a, 218b may each be transceivers that perform transmit/receive functions for the associated SIM of the MSMA communication device 200. The RF resources 218a, 218b may include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

In some embodiments, the general purpose processor 206, the memory 214, the baseband processor(s) 216, and the RF resources 218a, 218b may be included in the MSMA communication device 200 as a system-on-chip. In some embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the MSMA communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the MSMA communication device 200 to enable communication between them, as is known in the art.

In some embodiments (not shown), the MSMA communication device 200 may include, among other things, additional SIM cards, SIM interfaces, a plurality of RF resources associated with the additional SIM cards, and additional antennae for connecting to additional mobile networks.

The MSMA communication device 200 may optionally include a coexistence management unit 230 configured to manage and/or schedule utilization of the RF resources 218a, 218b. For example, the coexistence management unit 230 may configure an aggressor subscription to perform Tx blanking on its data channel(s) during a victim subscription's scheduled reception activities. In particular embodiments, the coexistence management unit 230 may be implemented within the general purpose processor 206. In some embodiments, the coexistence management unit 230 may be implemented as a separate hardware component (i.e., separate from the general purpose processor 206). In some embodiments, the coexistence management unit 230 may be implemented as a software application stored within the memory 214 and executed by the general purpose processor 206.

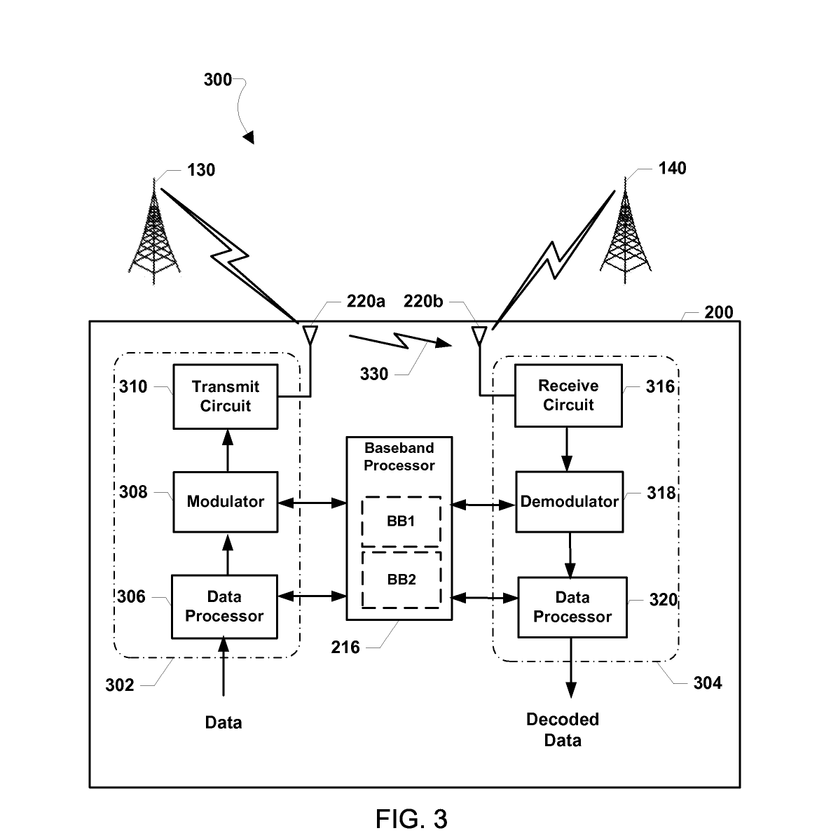

FIG. 3 illustrates a block diagram 300 of transmit and receive components in separate RF resources on the MSMA communication device 200 as described with reference to FIGS. 1-2 according to various embodiments. With reference to FIGS. 1-3, for example, a transmitter 302 may be part of the RF resource 218a, and a receiver 304 may be part of the RF resource 218b. In particular embodiments, the transmitter 302 may include a data processor 306 that may format, encode, and interleave data to be transmitted. The transmitter 302 may include a modulator 308 that modulates a carrier signal with encoded data, such as by performing Gaussian minimum shift keying (GMSK). One or more transmit circuits 310 may condition the modulated signal (e.g., by filtering, amplifying, and upconverting) to generate an RF modulated signal for transmission. The RF modulated signal may be transmitted, for example, to the first base station 130 via the first wireless antenna 220a.

At the receiver 304, the second wireless antenna 220b may receive RF modulated signals from the second base station 140. However, the second wireless antenna 220b may also receive some RF signaling 330 from the transmitter 302, which may ultimately compete with the desired signal received from the second base station 140. One or more receive circuits 316 may condition (e.g., filter, amplify, and downconvert) the received RF modulated signal, digitize the conditioned signal, and provide samples to a demodulator 318. The demodulator 318 may extract the original information-bearing signal from the modulated carrier wave, and may provide the demodulated signal to a data processor 320. The data processor 320 may de-interleave and decode the signal to obtain the original, decoded data, and may provide decoded data to other components in the MSMA communication device 200. Operations of the transmitter 302 and the receiver 304 may be controlled by a processor, such as the baseband processor(s) 216. In various embodiments, each of the transmitter 302 and the receiver 304 may be implemented as circuitry that may be separated from their corresponding receive and transmit circuitries (not shown). Alternatively, the transmitter 302 and the receiver 304 may be respectively combined with corresponding receive circuitry and transmit circuitry (i.e., as transceivers associated with the SIM-1 204a and the SIM-2 204b).

Receiver de-sense may occur when data associated with a first subscription transmitted on the uplink (e.g., the RF signaling 330) interferes with receive activity on a different transmit/receive chain that may be associated with a second subscription. The desired signals may become corrupted and difficult or impossible to decode. Further, noise from the transmitter 302 may be detected by a power monitor (not shown) that measures the signal strength of surrounding cells, which may cause the MSMA communication device 200 to falsely determine the presence of a nearby cell site.

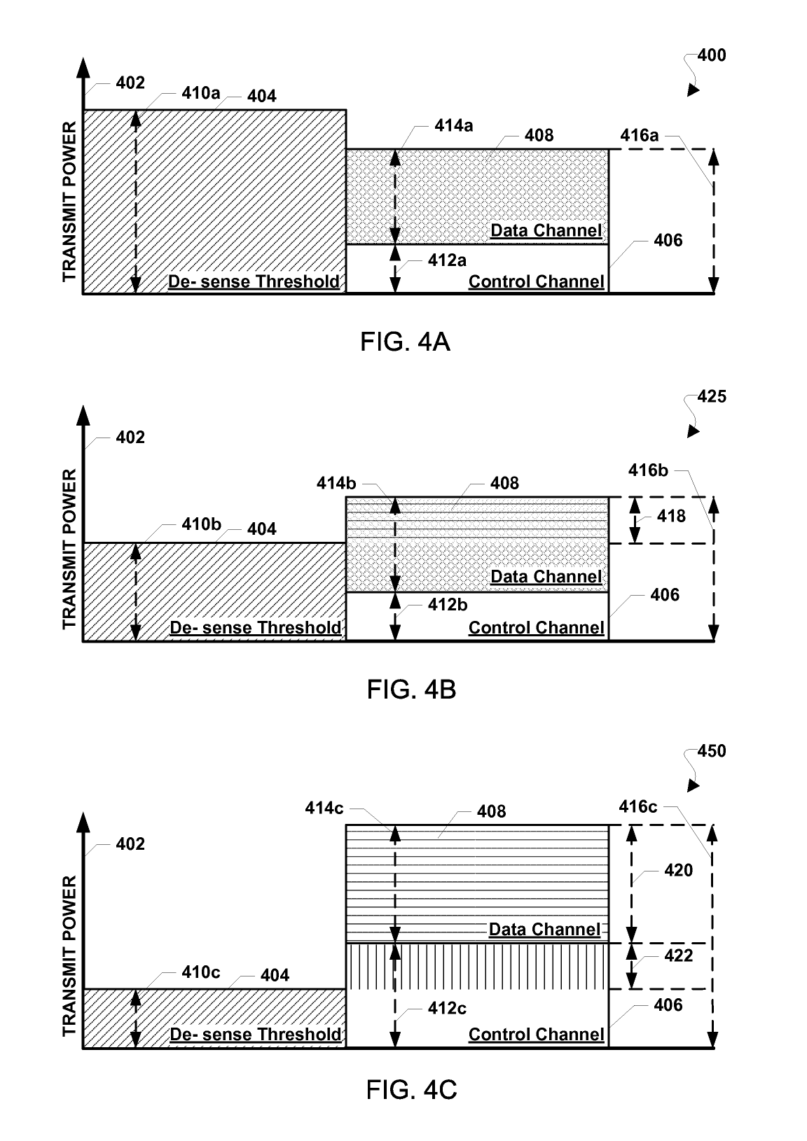

However, reducing/blanking an aggressor subscriptions control channel to reduce victim de-sense may drastically reduce the aggressor subscription's throughput and performance. To prevent this when circumstances permit, in various embodiments the aggressor subscription may be configured to reduce/blank its data channel(s) before reducing/blanking its control channel to ensure that the aggressor subscription's total transmit power does not exceed a de-sense power threshold as further described below (e.g., with reference to FIGS. 4A-4C).

As an illustration, FIGS. 4A-4C are graphs 400, 425, 450 comparing the transmit powers values of an aggressor subscription's data channel 408 and control channel 406 with a de-sense power threshold 404 as represented on the vertical axis (i.e., transmit power axis 402). As described above, the de-sense power threshold 404 may represent the maximum power at which an aggressor subscription may transmit without de-sensing a victim (or without de-sensing a victim beyond a certain acceptable tolerance).

As shown in the example graph 400 that is FIG. 4A, the de-sense power threshold 404 may correspond to a transmit power threshold value 410a that is greater than the aggressor subscription's total transmit power 416a. In some embodiments, the total transmit power 416a may be the sum of a transmit power 412a of the control channel 406 and a transmit power 414a of the data channel 408. Because the victim subscription is not being de-sensed (or is not being de-sensed beyond an acceptable limit), a processor operating on the MSMA communication device (e.g., the general purpose processor 206, the baseband modem processor 216, the coexistence management unit 230, a separate controller, and/or the like as described above with reference to FIG. 2) may not need to reduce either the transmit power 414a of the data channel 408 or the transmit power 412a of the control channel 406.

However, the device processor may need to reduce a total transmit power 416b of the aggressor subscription when the total transmit power 416b exceeds a transmit power threshold value 410b of the de-sense power threshold 404, as illustrated in the example graph 425 that is FIG. 4B. In some embodiments, the device processor may determine whether the transmit power 414b of the data channel 408 may be reduced to decrease the total transmit power 416b to equal the transmit power threshold value 410b. The device processor may determine that the transmit power 414b of the data channel 408 may be reduced by a certain amount (i.e., a transmit power reduction value 418) to ensure that a total transmit power 416b of the aggressor subscription does not exceed the transmit power threshold value 410b. In some embodiments, the device processor may not reduce a transmit power 412b of the control channel 406 when it is possible to keep the total transmit power 416b from exceeding the transmit power threshold value 410b by reducing only the transmit power 414b of the data channel 408.

As illustrated in the example graph 450 that is FIG. 4C, a transmit power threshold value 410c of the de-sense power threshold 404 may be significantly less than the sum of a transmit power 412c of the control channel and a transmit power 414c of the data channel 408 (i.e., a total transmit power 416c). For example, the transmit power threshold value 410c of the de-sense power threshold 404 may be low to accommodate especially sensitive or important reception activities performed by a victim subscription (e.g., receiving an emergency call). As another example, the transmit power threshold value 410c may remain the same or change slightly, but the transmit power 412c of the control channel 406 and/or the transmit power 414c of the data channel 408 may increase to maintain a satisfactory connection with the aggressor's mobile network as the MSMA communication device moves farther away from a base station on which the aggressor subscription is currently camped.

In response to determining that the transmit power threshold value 410c of the de-sense power threshold 404 is less than the total transmit power 416c, the device processor may reduce the transmit power 414c of the data channel 408 by a certain amount, referred to herein as a transmit power reduction value 420. In the example illustrated in FIG. 4C, reducing the total transmit power 416c by the transmit power reduction value 420 may not be sufficient to prevent the victim subscription from being de-sensed. This may occur in circumstances in which, even when the transmit power 414c of the data channel 408 is zeroed, the transmit power 412c of the control channel 406 still exceeds the transmit power threshold value 410c. To address such circumstances, in response to determining that zeroing the transmit power 414c of the data channel 408 is not sufficient to ensure that the total transmit power 416c does not exceed the transmit power threshold value 410c of the de-sense power threshold 404, the device processor may reduce the transmit power 412c of the control channel 406 by an amount referred to herein as a transmit power reduction value 422 so that the total transmit power 416c does not exceed the transmit power threshold value 410c. Thus in some embodiments, the total transmit power 416c may be adjusted to not exceed the transmit power threshold value 410c after the device processor has reduced the total transmit power 416c by zeroing the transmit power 414c of the data channel 408 by reducing the transmit power 412c of the control channel 406 by the transmit power reduction value 422.

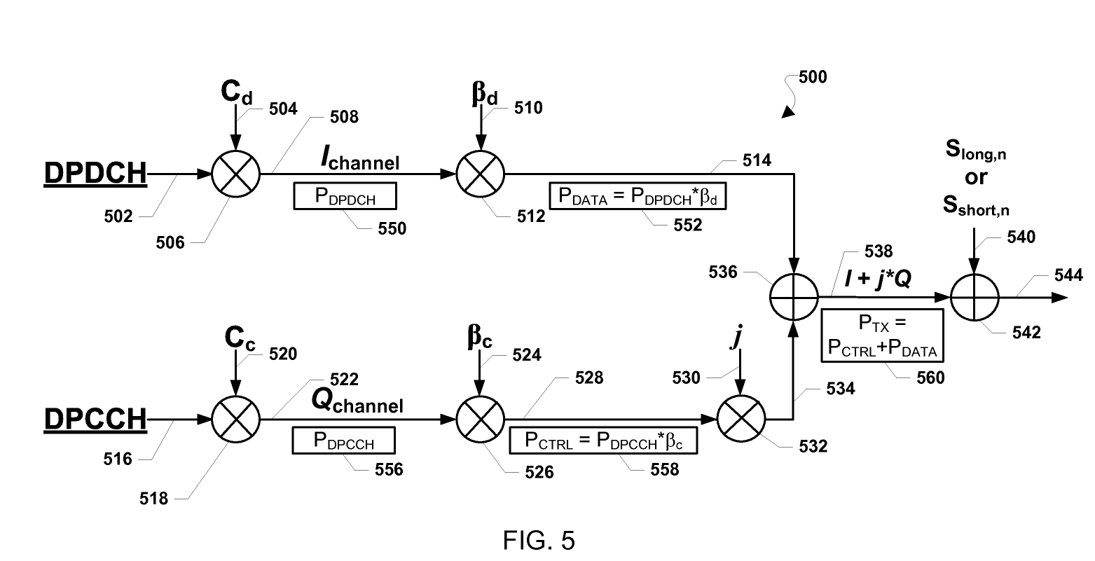

FIG. 5 illustrates a signaling diagram 500 for in-phase and quadrature-phase (“IQ”) uplink modulation of data and control channels of an example UMTS aggressor subscription operating on an MSMA communication device (e.g., the MSMA communication device 200 described above with reference to FIGS. 2-3) according to some embodiments. As illustrated in FIG. 5, a device processor operating on the MSMA communication device (e.g., the general purpose processor 206, the coexistence management unit 230, or the baseband modem processor 216 as described above with reference to FIG. 2) may apply a data channel channelization code 504 (“C_{d}”) to the aggressor subscription's dedicated physical data channel 502 (“DPDCH”) at a multiplier 506 to produce an “in-phase” data channel 508 (“I_{channel}”) using known techniques. The in-phase data channel 508 of the aggressor subscription may have a full or maximum transmit power 550 (“P_{DPDCH}”).

As described above, the aggressor subscription's total transmit power (i.e., the sum of the transmit powers of the aggressor subscription's data and control channels) may cause the aggressor subscription's transmissions to de-sense one or more victim subscriptions, in response to which the device processor may initially attempt to prevent such de-sense by first reducing the transmit power of the aggressor subscription's data channels. Thus, during a coexistence event, the device processor may adjust/reduce the maximum transmit power 550 of the in-phase data channel 508 by applying a data channel gain 510 (i.e., β_{d}) to the maximum transmit power 550 at a multiplier 512 to produce an adjusted in-phase data channel 514 with an adjusted transmit power 552 (“P_{DATA}”) equal to the maximum transmit power 550 multiplied by the data channel gain 510 (i.e., “P_{DATA}=P_{DPDCH}* β_{d}”). For example, the device processor may reduce the maximum transmit power 550 of the in-phase data channel 508 by 80% by applying a data channel gain equal to “0.8.”

In some embodiments in which the aggressor subscription is associated with a plurality of data channels, the device processor may apply the same data channel gain 510 to each of the plurality of data channels so as to uniformly adjust/reduce the channelization powers for each of the plurality of data channels. In some embodiments, the device processor may selectively apply different data channel gains to one or more of the plurality of data channels, such as zeroing/reducing some data channels' channelization power but not others.

The device processor may apply a control channel channelization code 520 (“C_{c}”) to a dedicated physical control channel 516 (“PDCCH”) of the aggressor subscription at a multiplier 518 to produce a “quadrature-phase” control channel 522 (“Q_{channel}”) with a maximum or full transmit power 556 (“P_{DPCCH}”).

As similarly described above with reference to the in-phase data channel 508, the device processor may adjust/reduce the maximum transmit power 556 of the quadrature-phase control channel 522 in response to determining that zeroing the maximum transmit power 550 of the in-phase data channel 508 is insufficient to prevent a victim subscription from being de-sensed. Thus, based on this determination, the device processor may apply a control channel gain 524 (i.e., “β_{c}”) to the maximum transmit power 556 of the quadrature-phase control channel 522 at a multiplier 526 to produce an adjusted quadrature-phase control channel 528 with an adjusted transmit power 558 (“P_{CTRL}”) that does not exceed a de-sense power threshold as described above.

The device processor may further adjust the adjusted quadrature-phase control channel 528 by a scaled value 530 (“j”) at a multiplier 532 to produce a scaled quadrature-phase control channel 534 using known techniques. The device processor may also combine the scaled quadrature-phase control channel 534 with the adjusted in-phase data channel 514 at an adder 536 to produce a combined channel 538, represented in FIG. 5 as “I+j* Q.” In some embodiments, the combined channel 538 may have a total transmit power 560 (“P_{TX}”) equal to the sum of the adjusted transmit power 552 of the adjusted in-phase data channel 514 and the adjusted transmit power 558 of the adjusted quadrature-phase control channel 528 (i.e. “P_{TX}=P_{CTRL}+P_{DATA}”).

Thus, in various embodiments the device processor may ensure that the total transmit power 560 is below a de-sense threshold value by adjusting/reducing the maximum transmit power 550 of the in-phase data channel or by adjusting/reducing both of the maximum transmit powers 550, 556 of the in-phase data channel 508 and the quadrature-phase control channel 522 before those channels 508, 522 are combined/multiplexed together.

The device processor may apply a scrambling code 540 (labeled in FIG. 5 as “S_{long, n} or S_{short, n}”) to the combined channel 538 at an adder 542 to produce a scrambled channel 544 using known techniques. The device processor may also cause the scrambled channel 544 to be transmitted over the air according to known methods.

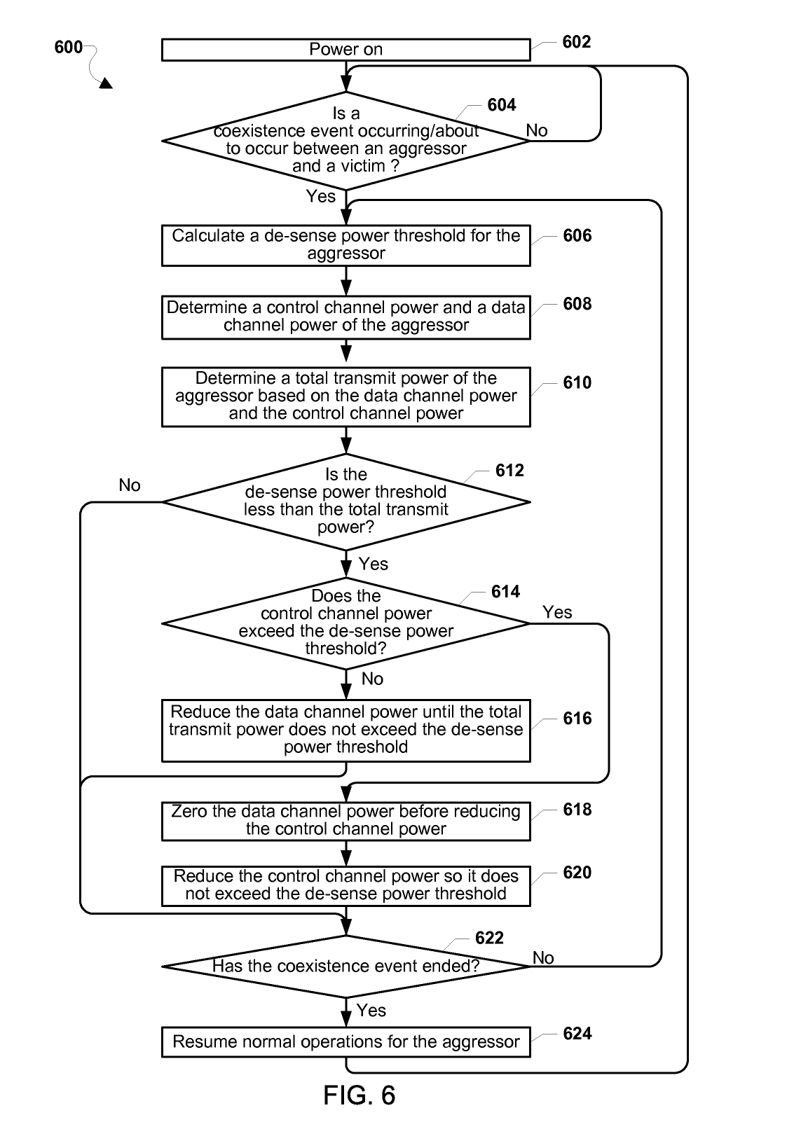

FIG. 6 illustrates a method 600 that may be implemented by a processor executing on a MSMA communication device (e.g., the general purpose processor 206, a coexistence management unit 230, or the baseband modem processor 216 as described above with reference to FIG. 2) for reducing only the transmit power of a data channel or reducing both the transmit powers of the data channel and a control channel of an aggressor subscription in response to determining that the aggressor subscription is de-sensing a victim subscription according to some embodiments. With reference to FIGS. 1-6, the device processor may begin performing the operations of the method 600 in response to the MSMA communication device's powering on in block 602.

In determination block 604, the device processor may determine whether a coexistence event is occurring between an aggressor subscription and a victim subscription. As described above, the coexistence event may occur when the transmissions of an aggressor subscription de-sense or otherwise interfere with the reception activities and/or performance of the victim subscription. In some embodiments, the device processor may determine whether the coexistence event will occur or is about to occur in determination block 604. In such embodiments, the device processor may preemptively identify when a victim subscription is at risk of de-sense (e.g., based on the transmission patterns of the aggressor and/or the reception schedule of the victim and/or based on the band-channel combinations of the aggressor and victim subscriptions) and may perform the following operations to prevent victim de-sense instead of mitigating de-sense that is already occurring.

In response to determining that a coexistence event is not occurring or is not about to occur between a aggressor subscription and a victim subscription (i.e., determination block 604=No”), the device processor may repeat the operations in determination block 604 until the device processor determines that a coexistence event is occurring between a aggressor subscription and a victim subscription. In other words, the device processor may not reduce the transmit power of a subscription's data or control channels so long as that subscription is not de-sensing or is not about to de-sense another subscription.

In response to determining that a coexistence event is occurring (or is about to occur) between a aggressor subscription and a victim subscription (i.e., determination block 604=“Yes”), the device processor may calculate a de-sense power threshold for the aggressor subscription in block 606, such as by calculating the maximum power at which the aggressor subscription may transmit without de-sensing the victim subscription beyond an acceptable amount. In some embodiments, the device processor may dynamically set the de-sense power threshold based on the priority of the victim subscription's reception activities and/or the aggressor subscription's transmission activities. For example, the de-sense power threshold may be a relatively high value when the victim is performing critical or important reception activities (e.g., receiving or placing an emergency call), but the device processor may lower the de-sense power threshold in response to determining that the victim subscription is now performing lower-priority reception activities.

In some embodiments, there may be multiple victim subscriptions that are de-sensed by the aggressor subscription's transmissions during the coexistence event. In such embodiments, the de-sense power threshold may represent a transmit power limit for the aggressor subscription that accounts for the multiple victim subscriptions performing reception activities during the coexistence event. In other words, the device processor may compare the aggressor subscription's total transmit power with the de-sense power threshold to ensure that the aggressor does not de-sense one or more of the multiple victims.

In some embodiments, multiple aggressor subscriptions may de-sense one or more victim subscriptions during the coexistence event. In such embodiments, each aggressor subscription's total transmit power may be limited by a de-sense power threshold (e.g., a threshold that applies to all aggressor subscriptions or a specifically-tailored threshold for each aggressor subscription) that ensures that the combined transmission activities of the aggressors subscriptions do not de-sense the one or more victim subscriptions (i.e., a plurality of other communication activities).

In block 608, the device processor may determine both a control channel power and a data channel power of the aggressor subscription. For instance, as described, the control channel power may be the transmit power of the aggressor subscription's control channel after channelization but before applying a control channel gain (e.g., the control channel gain 520 or “β_{c}”). Similarly, the data channel power may be the transmit power of the one or more data channels of the aggressor subscription after channelization and before applying the data channel gain multiplier (e.g., the data channel gain 510 or “β_{d}”). In other words, the control channel power and data channel power may reflect the maximum possible transmit powers of the control channel and the data channel, respectively, before those channels are multiplexed and output over the air. By determining the maximum acceptable transmit power of the control channel and the data channel in view of the victim subscription(s), the device processor may be able to determine the extent to which the transmit power of the data channel or the transmit powers of the data channel and the control channel must be reduced as further described below.

In block 610, the device processor may determine the total transmit power of the aggressor subscription based on the data channel power and the control channel power as determined in block 608 and as described above (e.g., with reference to FIG. 5). In some embodiments, the total transmit power may be equal to a sum of the data channel power and the control channel power.

In determination block 612, the device processor may determine whether the de-sense power threshold calculated in block 606 is less than the total transmit power as determined in block 610. In some embodiments, the device processor may compare the aggressor subscription's total transmit power with the de-sense power threshold to determine whether the aggressor subscription is de-sensing the victim subscription.

In response to determining that the de-sense power threshold exceeds or equals the total transmit power (i.e., determination block 612=“No”), the device processor may not reduce either the data channel power or the control channel power of the aggressor subscription and may continue performing operations of the method 600 in determination block 622 as described below. Thus, in response to determining that the data channel and the control channel may be transmitted at a maximum power (i.e., a full allowable gain) without de-sensing a victim subscription, the device processor may not reduce either the data channel power or the control channel power of the aggressor subscription.

In response to determining that the de-sense power threshold is less than the total transmit power (i.e., determination block 612=“Yes”), the device processor may determine (determination block 614) whether the control channel power determined in block 608 exceeds the de-sense power threshold as calculated in block 606. In other words, in response to determining that the aggressor subscription is de-sensing the victim subscription in determination block 612, the device processor may determine whether reducing the data channel power alone (i.e., without also reducing the control channel power) is sufficient to prevent the aggressor subscription from de-sensing the victim subscription.

In response to determining that the control channel power does not exceed the transmit power (i.e., determination block 614=“No”), the device processor may reduce the data channel power until the total transmit power does not exceed the de-sense power threshold, in block 616. In some embodiments, the device processor may reduce the data channel power until the total transmit power (i.e., the sum of the control channel power and the reduced data channel power) does not exceed the de-sense power threshold as described in the disclosure (e.g., with reference to FIG. 4B), thereby ensuring that the aggressor's transmissions will not de-sense the victim subscription beyond an acceptable amount. Further, the device processor may not reduce the control channel's transmit power (i.e., the control channel may be transmitted at a maximum allowable gain). In some embodiments, the device processor may reduce the data channel power by applying a data channel gain (e.g., the data channel gain 510 or “β_{d}”) to the data channel power after channelization (e.g., as described with reference to FIG. 5). Thus, by reducing the data channel power and not reducing the control channel power, the victim subscription may avoid an unacceptable level of de-sense, and the aggressor subscription may maintain a satisfactory throughput and connection with its mobile network.

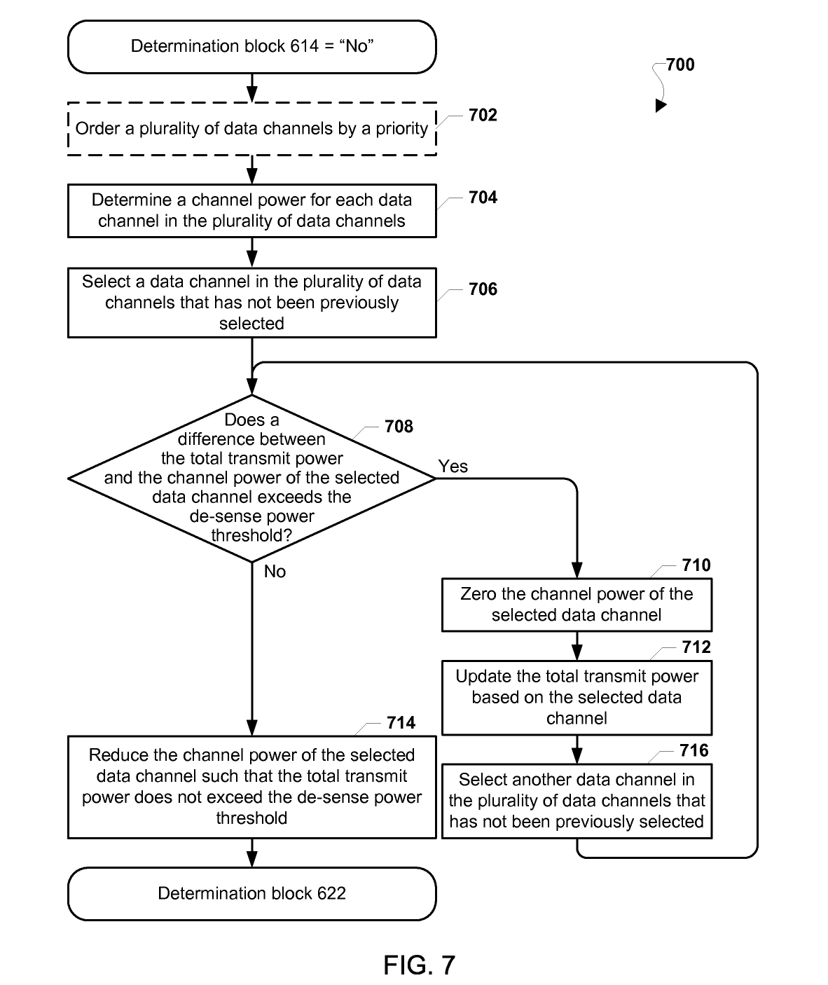

In some embodiments, the aggressor subscription may have a plurality of data channels. Each of the plurality of data channels may be associated with a separate transmit power, and the plurality of data channels may be transmitted in parallel. In some embodiments the device processor may reduce the transmit power of each of the plurality of data channels equally in block 616. For example, the device processor may calculate that the collective transmit power of the plurality of data channels needs to be reduced by five percent to ensure that the total transmit power of the aggressor subscription does not exceed the de-sense power threshold, in which case the device processor may reduce each of the plurality of data channels by five percent. In some embodiments, the device processor may selectively reduce one or more of the plurality of data channels without reducing other data channels as further described in the disclosure (e.g., with reference to FIG. 7).

The device processor may continue performing the operations of the method 600 in determination block 622 as further described below.

In response to determining that the control channel power exceeds the de-sense power threshold (i.e., determination block 614=“Yes”), the device processor may zero the data channel in block 618 before reducing the control channel power in block 620. When the control channel power exceeds the de-sense power threshold, the device processor may reduce the data channel entirely before reducing the control channel power to afford the control channel the most power possible without causing the victim to suffer de-sense above the de-sense power threshold. For example, the device processor may apply a zero data channel gain (i.e., β_{d}=0) to the data channel power after channelization as described in the disclosure (e.g., with reference to FIG. 5).

In block 620, the device processor may reduce the control channel power to ensure that the control channel power does not exceed the de-sense power threshold. For example, the device processor may cause the aggressor's control channel power to equal the de-sense power threshold (e.g., as described with reference to FIG. 4C) by applying a control channel gain (i.e., β_{c}) to the control channel power after channelization as described in the disclosure (e.g., with reference to FIG. 5).

In response to determining that the de-sense power threshold exceeds the total transmit power (i.e., determination block 612=“Yes”), in response to reducing the data channel power in block 616, or in response to reducing the control channel power in block 620, the device processor may determine whether the coexistence event has ended in determination block 622. In some embodiments the device processor may determine whether the victim subscription is still at risk of being de-sensed in determination block 622. For example, the coexistence event may be ongoing when the victim continues performing reception activities that may be de-sensed by the aggressor's transmission. In another example, the coexistence event may end when the victim subscription is no longer performing reception activities, when the aggressor subscription has ceased transmitting, or when the aggressor subscription and the victim subscription's band-channel combination changes such that the victim is no longer at risk of de-sense.

In response to determining that the coexistence event has not ended (i.e., determination block 622=“No”), the device processor may repeat the operations described above in a loop by re-calculating a de-sense power threshold for the aggressor subscription in block 606. In some embodiments, while the coexistence event is ongoing, the device processor may repeat the above operations once for each uplink transmit cycle. For example, for an aggressor subscription utilizing the Universal Mobile Telecommunications System (“UMTS”), the device processor may repeat the above operations every ten milliseconds for the aggressor subscription while the coexistence event is ongoing.

In response to determining that the coexistence event has ended (i.e., determination block 622=“Yes”), the device processor may configure the aggressor subscription to resume normal operations in block 624. In some embodiments, the transmit power of the aggressor subscription's data and control channels may no longer be reduced because the coexistence event is over (i.e., there is no risk of de-sensing a victim subscription). The device processor may repeat the above operations in a loop by determining whether another coexistence event is occurring between an aggressor subscription and a victim subscription in determination block 604.

FIG. 7 illustrates a method 700 that may be implemented by a processor executing on an MSMA communication device (e.g., the general purpose processor 206, the coexistence management unit 230, or the baseband modem processor 216 as described above with reference to FIG. 2) for reducing the transmit power of one or more data channels according to various embodiments. The operations of the method 700 implement some embodiments of the operations performed in block 616 of the method 600 described with reference to FIG. 6. Thus, with reference to FIGS. 1-7, the device processor may begin performing the operations of the method 700 in response to determining that the control channel power does not exceed the de-sense power threshold (i.e., determination block 614=“No”).

As described (e.g., with reference to FIG. 6), the aggressor subscription may be associated with a plurality of data channels transmitted in parallel and a control channel, and the total transmit power determined in block 610 of the method 600 may include the transmit powers of each of the plurality of data channels and the transmit power of the control channel.

In some embodiments, the device processor may reduce the transmit power of each of the plurality of data channels by an equal amount to ensure that the total transmit power does not exceed the de-sense power threshold. Uniformly reducing the transmit power of the data channels may be effective in circumstances in which each of the plurality of data channels has the same priority. For example, each of the plurality of data channels may be used for transmitting high-priority data. Thus, while the data channels must be reduced to make sure that the total transmit power does not exceed the de-sense power threshold as described above, the impact is applied evenly across the plurality of data channels.

In some embodiments, the device processor may reduce the transmit power of some of the plurality of data channels and not others. For example, one or more data channels may transmit higher-priority data than other data channels, and the device processor may attempt to avoid reducing the transmit power of those higher-priority data channels at the expense of lower-priority data channels. Thus, in some embodiments, the device processor may optionally order a plurality of data channels by a priority in optional block 702. For example, the data channels may be ranked based on the priority of their data and/or numerous other criteria.

In block 704, the device processor may determine a channel power for each data channel in the plurality of data channels. In some embodiments, the device processor may determine a data channel power for each data channel after the data channel's channelization and before the data channel is multiplexed for over-the-air transmission as described (e.g., with reference to FIG. 5). The device processor may also select a data channel in the plurality of data channels that has not been previously selected, in block 706. In some embodiments, the device processor may select a data channel based on the data channel's priority relative to other data channels in the plurality of data channels (e.g., a low-priority data channel).

In determination block 708, the device processor may determine whether a difference between the total transmit power determined in block 610 and the channel power of the selected data channel determined in block 704 exceeds the de-sense power threshold calculated in block 606. In other words, the device processor may determine whether reducing the selected data channel's transmit power may cause the total transmit power to be less than or equal to the de-sense power threshold.

In response to determining that the difference between the total transmit power and the channel power of the selected data channel exceeds the de-sense power threshold (i.e., determination block 708=“Yes”), the device processor may zero the channel power of the selected data channel in block 710. In some embodiments, rather than reducing each of the plurality of data channels equally, the device processor may reduce the selected data channel's channel power to zero before reducing another data channel's transmit power. The device processor may also update the total transmit power to reflect the zeroed transmit power of the selected channel, in block 712.

In the event that the total transmit power exceeds the de-sense power threshold even after zeroing the selected data channel's channel power, the device processor may need to reduce the transmit power of one or more other data channels. Thus, in block 716, the device processor may select another data channel in the plurality of data channels that has not been previously selected and may repeat the operations of the method 700 starting in determination block 708 by determining whether the difference between the updated total transmit power and the channel power of the newly selected data channel exceeds the de-sense power threshold.

In response to determining that the difference between the total transmit power and the channel power of the selected data channel does not exceed the de-sense power threshold (i.e., determination block 708=“No”), the device processor may reduce the channel power of the selected data channel such that the total data channel power does not exceed the de-sense power threshold, in block 714. In some embodiments, the device processor may only reduce the channel power of the selected data channel to the point at which the total transmit power equals the de-sense power threshold. In other words, the device processor may reduce the channel power of the selected data channel without zeroing the channel power.

Following block 714, the device processor may determine whether the coexistence event is over in determination block 622 and may proceed with the operations of method 600.

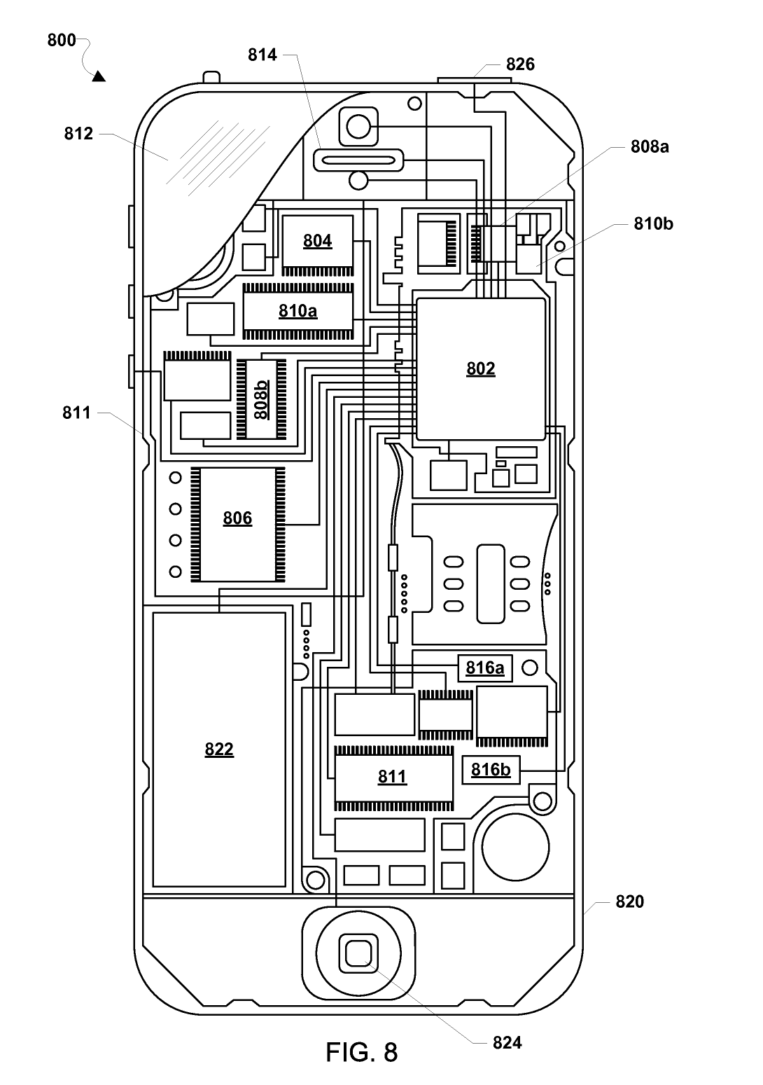

Various embodiments may be implemented in any of a variety of MSMA communication devices, an example of which (e.g., an MSMA communication device 800) is illustrated in FIG. 8. According to various embodiments, the MSMA communication device 800 may be similar to the MSMA communication devices 110, 120, 200 as described above with reference to FIGS. 1-3. As such, the MSMA communication device 800 may implement the methods 600, 700.

The MSMA communication device 800 may include a processor 802 coupled to a touchscreen controller 804 and an internal memory 806. The processor 802 may be one or more multi-core integrated circuits designated for general or specific processing tasks. The internal memory 806 may be volatile or non-volatile memory, and may also be secure and/or encrypted memory, or unsecure and/or unencrypted memory, or any combination thereof. The touchscreen controller 804 and the processor 802 may also be coupled to a touchscreen panel 812, such as a resistive-sensing touchscreen, capacitive-sensing touchscreen, infrared sensing touchscreen, etc. Additionally, the display of the MSMA communication device 800 need not have touch screen capability.

The MSMA communication device 800 may have one or more cellular network transceivers 808a, 808b coupled to the processor 802 and to two or more antennae 810 and configured for sending and receiving cellular communications. The transceivers 808 and antennae 810a, 810b may be used with the above-mentioned circuitry to implement the various embodiment methods. The MSMA communication device 800 may include two or more SIM cards 816a, 816b coupled to the transceivers 808a, 808b and/or the processor 802 and configured as described above. The MSMA communication device 800 may include a cellular network wireless modem chip 811 that enables communication via a cellular network and is coupled to the processor.

The MSMA communication device 800 may also include speakers 814 for providing audio outputs. The MSMA communication device 800 may also include a housing 820, constructed of a plastic, metal, or a combination of materials, for containing all or some of the components discussed herein. The MSMA communication device 800 may include a power source 822 coupled to the processor 802, such as a disposable or rechargeable battery. The rechargeable battery may also be coupled to a peripheral device connection port (not shown) to receive a charging current from a source external to the MSMA communication device 800. The MSMA communication device 800 may also include a physical button 824 for receiving user inputs. The MSMA communication device 800 may also include a power button 826 for turning the MSMA communication device 800 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method implemented on a multi-Subscriber-Identity-Module (SIM), multi-active communication device for mitigating de-sense on a second communication activity caused by a first communication activity, comprising:
calculating within the multi-SIM-multi-active communication device a de-sense power threshold for the first communication activity as a maximum transmit power of the first communication activity that does not de-sense the second communication activity, in response to detecting a coexistence event between the first communication activity and the second communication activity; and
reducing at least one of a data channel power and a control channel power of the first communication activity within the multi-SIM-multi-active communication device such that a total transmit power associated with the first communication activity equal to a sum of the data channel power and the control channel power does not exceed the de-sense power threshold, wherein the data channel power is reduced to zero before the control channel power is reduced.

2. The method of claim 1, wherein detecting a coexistence event between the first communication activity and the second communication activity comprises one of:
determining that a coexistence event is about to occur between the first communication activity and the second communication activity; and
determining that a coexistence event is occurring between the first communication activity and the second communication activity.

3. The method of claim 1, wherein reducing at least one of a data channel power and a control channel power of the first communication activity comprises:
determining whether the de-sense power threshold is less than the total transmit power;
determining whether the control channel power exceeds the de-sense power threshold, in response to determining that the de-sense power threshold is less than the total transmit power; and
reducing only the data channel power so that the total transmit power does not exceed the de-sense power threshold, in response to determining that the control channel power does not exceed the de-sense power threshold.

4. The method of claim 3, further comprising zeroing the data channel power before reducing the control channel power to equal the de-sense power threshold, in response to determining that the control channel power exceeds the de-sense power threshold.

5. The method of claim 1, wherein:
the first communication activity is associated with a plurality of data channels; and
reducing at least one of a data channel power and a control channel power of the first communication activity comprises:
selecting a data channel in the plurality of data channels;
determining whether a difference between the total transmit power and a channel power of the selected data channel exceeds the de-sense power threshold; and
reducing the channel power of the selected data channel so that the total transmit power does not exceed the de-sense power threshold, in response to determining that the difference does not exceed the de-sense power threshold.

6. The method of claim 5, further comprising zeroing the channel power of the selected data channel in response to determining that the difference exceeds the de-sense power threshold.

7. The method of claim 1, wherein each of calculating a de-sense power threshold and reducing at least one of a data channel power and a control channel power of the first communication activity such that a total transmit power associated with the first communication activity does not exceed the de-sense power threshold occurs during each uplink transmit cycle of the first communication activity.

8. The method of claim 1, wherein calculating a de-sense power threshold for the first communication activity comprises calculating the de-sense power threshold for the first communication activity as a maximum transmit power of the first communication activity that does not de-sense a plurality of other communication activities.

9. A multi-Subscriber-Identity-Module (SIM), multi-active communication device, comprising:
a memory;
a plurality of radio-frequency (RF) resources; and
a processor coupled to the memory, a plurality of SIMs, and the plurality of RF resources, wherein the processor is configured to:
calculate a de-sense power threshold for a first communication activity as a maximum transmit power of the first communication activity that does not de-sense a second communication activity, in response to detecting a coexistence event between the first communication activity and the second communication activity; and
reduce at least one of a data channel power and a control channel power of the first communication activity such that a total transmit power associated with the first communication activity equal to a sum of the data channel power and the control channel power does not exceed the de-sense power threshold, wherein the data channel power is reduced to zero before the control channel power is reduced.

10. The multi-SIM-multi-active communication device of claim 9, wherein the processor is further configured to:
determine that a coexistence event is about to occur between the first communication activity and the second communication activity; or
determine that a coexistence event is occurring between the first communication activity and the second communication activity.

11. The multi-SIM-multi-active communication device of claim 9, wherein the processor is further configured to:
determine whether the de-sense power threshold is less than the total transmit power;
determine whether the control channel power exceeds the de-sense power threshold, in response to determining that the de-sense power threshold is less than the total transmit power; and
reduce only the data channel power so that the total transmit power does not exceed the de-sense power threshold, in response to determining that the control channel power does not exceed the de-sense power threshold.

12. The multi-SIM-multi-active communication device of claim 11, wherein the processor is further configured to zero the data channel power before reducing the control channel power to equal the de-sense power threshold, in response to determining that the control channel power exceeds the de-sense power threshold.

13. The multi-SIM-multi-active communication device of claim 9, wherein:
the first communication activity is associated with a plurality of data channels; and
the processor is further configured to:
select a data channel in the plurality of data channels;
determine whether a difference between the total transmit power and a channel power of the selected data channel exceeds the de-sense power threshold; and
reduce the channel power of the selected data channel so that the total transmit power equals the de-sense power threshold, in response to determining that the difference does not exceed the de-sense power threshold.

14. The multi-SIM-multi-active communication device of claim 13, wherein the processor is further configured to zero the channel power of the selected data channel in response to determining that the difference exceeds the de-sense power threshold.

15. The multi-SIM-multi-active communication device of claim 9, wherein the processor is further configured to calculate the de-sense power threshold and reduce at least one of the data channel power and the control channel power of the first communication activity such that a total transmit power associated with the first communication activity does not exceed the de-sense power threshold during each uplink transmit cycle of the first communication activity.

16. The multi-SIM-multi-active communication device of claim 9, wherein the processor is further configured to calculate the de-sense power threshold for the first communication activity as a maximum transmit power of the first communication activity that does not de-sense a plurality of other communication activities.

17. A non-transitory processor-readable storage medium having stored thereon processor-executable instructions configured to cause a processor of a multi-Subscriber-Identity-Module (SIM), multi-active communication device to perform operations comprising:
calculating a de-sense power threshold for a first communication activity as a maximum transmit power of the first communication activity that does not de-sense a second communication activity, in response to detecting a coexistence event between the first communication activity and the second communication activity; and
reducing at least one of a data channel power and a control channel power of the first communication activity such that a total transmit power associated with the first communication activity equal to a sum of the data channel power and the control channel power does not exceed the de-sense power threshold, wherein the data channel power is reduced to zero before the control channel power is reduced.

18. The non-transitory processor-readable storage medium of claim 17, wherein the stored processor-executable instructions are configured to cause the multi-SIM-multi-active communication device processor to perform operations for detecting a coexistence event between the first communication activity and the second communication activity, the operations comprising at least one of:
determining that a coexistence event is about to occur between the first communication activity and the second communication activity; and
determining that a coexistence event is occurring between the first communication activity and the second communication activity.

19. The non-transitory processor-readable storage medium of claim 17, wherein the stored processor-executable instructions are configured to cause the multi-SIM-multi-active communication device processor to perform operations for reducing at least one of the data channel power and the control channel power of the first communication activity, the operations comprising:
determining whether the de-sense power threshold is less than the total transmit power;
determining whether the control channel power exceeds the de-sense power threshold, in response to determining that the de-sense power threshold is less than the total transmit power; and
reducing only the data channel power so that the total transmit power does not exceed the de-sense power threshold, in response to determining that the control channel power does not exceed the de-sense power threshold.

20. The non-transitory processor-readable storage medium of claim 19, wherein the stored processor-executable instructions are configured to cause the multi-SIM-multi-active communication device processor to perform operations further comprising zeroing the data channel power before reducing the control channel power to equal the de-sense power threshold, in response to determining that the control channel power exceeds the de-sense power threshold.

21. The non-transitory processor-readable storage medium of claim 17, wherein:
the first communication activity is associated with a plurality of data channels; and
the stored processor-executable instructions are configured to cause the multi-SIM-multi-active communication device processor to perform operations for reducing at least one of a data channel power and a control channel power of the first communication activity, the operations comprising:
selecting a data channel in the plurality of data channels;
determining whether a difference between the total transmit power and a channel power of the selected data channel exceeds the de-sense power threshold; and
reducing the channel power of the selected data channel so that the total transmit power equals the de-sense power threshold, in response to determining that the difference does not exceed the de-sense power threshold.

22. The non-transitory processor-readable storage medium of claim 21, wherein the stored processor-executable instructions are configured to cause the multi-SIM-multi-active communication device processor to perform operations further comprising zeroing the channel power of the selected data channel in response to determining that the difference exceeds the de-sense power threshold.

23. The non-transitory processor-readable storage medium of claim 17, wherein the stored processor-executable instructions are configured to cause the multi-SIM-multi-active communication device processor to perform operations such that each of calculating a de-sense power threshold and reducing at least one of a data channel power and a control channel power of the first communication activity such that a total transmit power associated with the first communication activity does not exceed the de-sense power threshold occurs during each uplink transmit cycle of the first communication activity.

24. The non-transitory processor-readable storage medium of claim 17, wherein the stored processor-executable instructions are configured to cause the multi-SIM-multi-active communication device processor to perform operations for calculating a de-sense power threshold for the first communication activity, the operations comprising calculating the de-sense power threshold for the first communication activity as a maximum transmit power of the first communication activity that does not de-sense a plurality of other communication activities.

25. A multi-Subscriber-Identity-Module (SIM), multi-active communication device, comprising:
means for calculating a de-sense power threshold for a first communication activity as a maximum transmit power of the first communication activity that does not de-sense a second communication activity, in response to detecting a coexistence event between the first communication activity and the second communication activity; and
means for reducing at least one of a data channel power and a control channel power of the first communication activity such that a total transmit power associated with the first communication activity equal to a sum of the data channel power and the control channel power does not exceed the de-sense power threshold, wherein the data channel power is reduced to zero before the control channel power is reduced.
